(19) United States
(12) Patent Application Publication
(10) Pub. No.: US 2004/0171307 A1
(43) Pub. Date: Sep. 2, 2004

(54) Universal wire harness for detectors

(76) Inventors: Mark A. Devine, Shorewood, IL (US); Michael A. Swieboda, Naperville, IL (US); Andrew J. Ivanecky, Aurora, IL (US)

Correspondence Address: WELSH & KATZ, LTD, 120 S RIVERSIDE PLAZA, 22ND FLOOR, CHICAGO, IL, 60606, US

(21) Appl. No.: 10/799,211

(22) Filed: Mar. 12, 2004

Related U.S. Application Data
(63) Continuation of application No. 10/612,317, filed on Jul. 2, 2003.
Application No. 10/612,317 is a division of application No. 09/886,907, filed on Jun. 21, 2001, now Pat. No. 6,641,433.

(51) Int. Cl. H01R 11/00

(52) U.S. Cl. 439/624

(57) ABSTRACT

An electrical unit, such as a fire or gas detector, carries a three conductor plug for receipt of energy, AC hot, and neutral, as well as for coupling to a bidirectional signaling line. A multiple conductor adapter makes it possible to couple the plug to a plurality of incompatible, previously installed sockets. The adapter can be fully contained in a single housing. Alternately, it can include a housing for some of the conductors with the remainder carried on a cable which extends from the housing.

### FIELD OF THE INVENTION

The invention pertains to AC-powered ambient condition detectors. More particularly, the invention pertains to connectors and adapters for coupling such detectors to existing AC sockets.

### BACKGROUND OF THE INVENTION

Fire detectors which can be battery powered or powered with utility supplied AC current are known. Battery powered detectors have become very popular as they are self-contained and can easily be installed almost anywhere. They are usually stand alone devices which do not interact with other similar detectors in the same region or installation.

Detectors which are coupled together by a communications line provide an alternate to stand alone, battery powered units. Such systems usually incorporate a three conductor cable. Two conductors (AC hot and neutral) provide electrical energy to power the detectors. A third conductor is used for signaling between detectors.

The cables terminate in three conductor sockets. A matching plug couples each detector to the cable.

Over a period of time, different socket/plug combinations have been used by manufacturers. In fact, there have been instances where a later model detector would not be compatible with previously installed sockets of the same manufacturer.

The problem of older, previously installed sockets impedes the replacement of older detectors with more current models. Where AC powered, or, interconnected detectors are installed in residences or small businesses, there may not be persons available who can safely remove the existing sockets and replace them with sockets compatible with more current models from the same or different manufacturers.

There is an on-going need to facilitate replacement of older AC powered, or, interconnected detectors with more current models. It would be most desirable if current detectors could be coupled to existing sockets without requiring any rewiring.

### SUMMARY OF THE INVENTION

A connection adapter which facilitates coupling electrical units, such as fire or gas detectors, heat detectors or the like, to electrical cables includes a non-conductive housing. The housing carries a first set of electrical conductors and a second set of electrical conductors. The number of conductors is the same for both sets.

The first set exhibits an electro-mechanical plug profile for engagement with socket elements of an existing connector. The second set exhibits an electro-mechanical socket profile for engagement with a second plug carried by a respective electrical unit.

In a disclosed embodiment, the electrical units are fire or gas detectors which are to receive electrical energy, from a remote source, via a respective electrical plug. One form of electrical energy is utility supplied AC.

The adapter interfaces between the electrical plug of the respective detector and an existing power distribution cable which has an existing socket with a profile that is unlike the plug. Where the cable carries AC, for example, the adapter converts the configuration of the existing AC socket to that of the plug which exhibits two contacts, AC hot and neutral for example.

In one form, the adapter has a single two sided housing. One side is a plug for mating with the existing AC connector at the cable. The other side is a socket for mating with the detector's plug.

In another embodiment, the adapter has a socket for engagement with the detector's plug. A plurality of conductors extends from the adapter. The conductors engage individual contacts of the socket carried by the cable to couple electrical energy form the cable to the respective detectors.

In yet another embodiment, the installed socket includes a third, signaling conductor. The adapter mates with the installed three conductor socket and with a three conductor plug carried by the electrical unit.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a block diagram of a system illustrating a problem solved by the present invention;

FIG. 2 is a schematic diagram illustrating exemplary wiring of a type found in systems as in FIG. 1;

FIG. 3 is a diagram of one embodiment of the present invention;

FIGS. 4A, B, taken together illustrate another embodiment of the invention;

FIG. 5 illustrates yet another embodiment of the invention; and

FIGS. 6A, B and C each illustrate two different views of an adapter which embodies the present invention.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

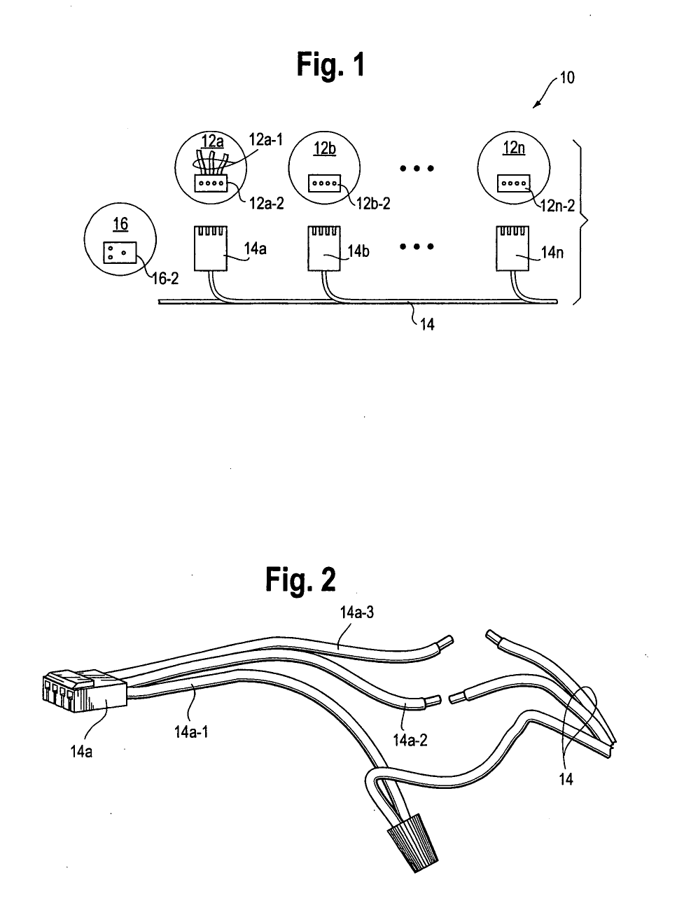

FIG. 1 illustrates a system 10 of ambient condition detectors 12a,b,c, . . . n. These detectors are all coupled to a multiple conductor cable, such as a two conductor AC utility line 14. The cable 14 can also include a third conductor for inter-detector signaling purposes as would be known to those of skill in the art.

Each of the detectors, such as 12a, has a plurality of internal conductors 12a-1 (indicated in phantom) which extends therefrom and which is terminated by a plug 12a-2 of a predetermined configuration. Each of the plugs 12a-2 . . . 12n-2 is compatible with and is intended to engage a corresponding socket, such as the sockets 14a,b,c,d . . . n carried on and coupled to the cable 14.

In known installations, sockets 14a,b,c,d . . . n mate with corresponding plugs 12a-2 . . . 12n-2 to couple power to the respective detector and to provide intra-detector signaling. Such configurations provide convenience in installation and safety by isolating the power contacts from direct access by installer or maintenance personnel.

The above described system 10 is limited in that a replacement detector 16 which has a plug 16-2 with a different configuration can not be installed to replace detector 12a without altering or replacing socket 14a. This exposes the AC power lines and requires skill to be carried out safely.

FIG. 2 illustrates socket 14a with three conductors 14a-1,-2,-3 coupled by wire nuts to multi-conductor cable 14. Changing socket 14a so as to be compatible with plug 16-2 requires removing the respective wire nuts and installing a socket compatible with plug 16-2.

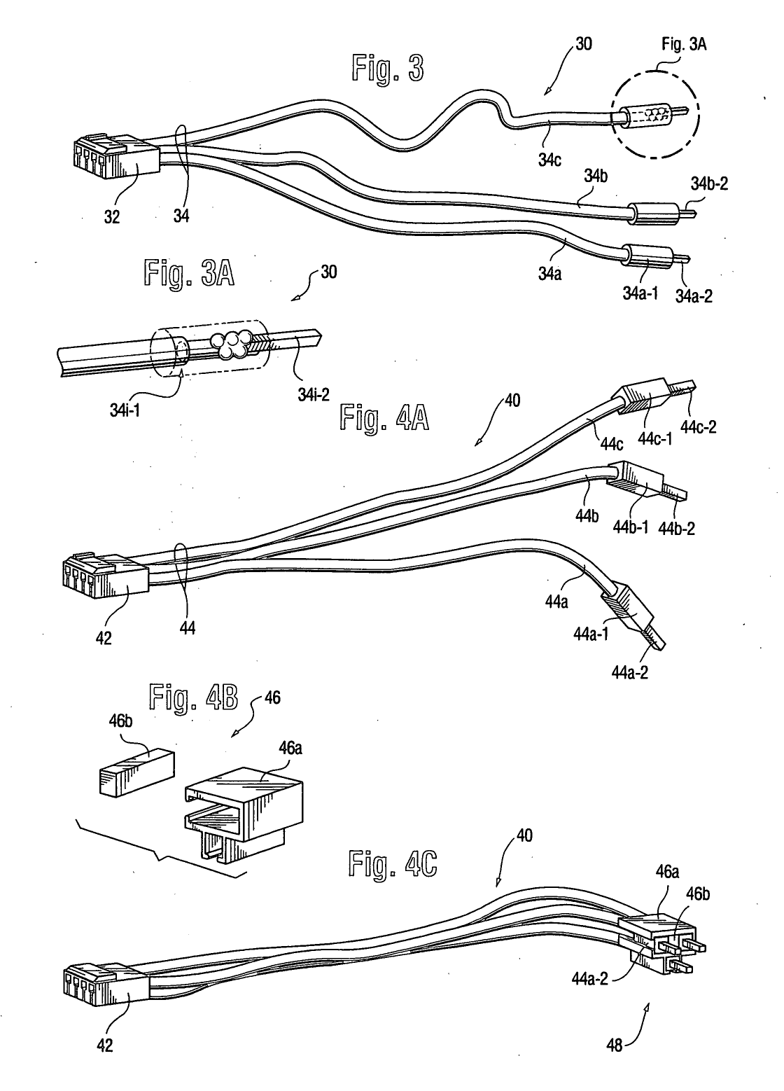

FIG. 3 illustrates an adapter 30 which can be used to couple plug 16-2 to socket 14a safely and without any need to alter or replace the existing sockets 12a,b,c,d . . . n. The adapter 30 includes a socket 32 which is compatible with plug 16-2. A plurality of conductors 34 extends from socket 32.

Each of the conductors 34a,b,c has a free end which carries an insulator, such as 34a-1. Each insulator covers a respective pin 34a-2 which is compatible with a respective socket-element in a socket such as socket 14a. The conductors 34a,b,c of adapter 30 are inserted into socket elements in socket 14a. Those pins thus engage the respective socket elements safely and conveniently. The plug 16-2 of replacement detector 16 can be coupled to adapter socket 32 so as to receive power and signals off of cable 14.

FIG. 4A illustrates an alternate adapter system 40. Adapter system 40 has a socket 42 which is compatible with plug 16-2. Conductors 44 extend from socket 42. A positioning, or locating element, such as 44a-1 is carried adjacent a free end of each conductor. Each conductor carries at the free end a respective pin, such as pin 44a-2.

FIG. 4B illustrates a configurable shell, or housing 46. Housing 46 includes a holder 46a and a spacer 46b. Positioning elements 44a-1,b-1,c-1 can be inserted into and locked in holder 46a, along with spacer 46b with an arrangement which is compatible with a respective socket such as socket 14a as illustrated in FIG. 4C. The pins 44a-2, b-2 and c-2 extend from holder 46a forming a plug 48.

The plug 48 is compatible with socket 14a while the socket 42 is compatible with plug 16-2. The detector 16 can now be safely and conveniently coupled to cable 14.

The adapter 40 can readily be configured by a home owner or other installer prior to any engagement with the respective socket such as socket 14a. Adapter 40 can be used with a variety of different sockets merely by rearranging the location of spacer 46b and the relative positions of the pins 44a-23, b-2 and c-2.

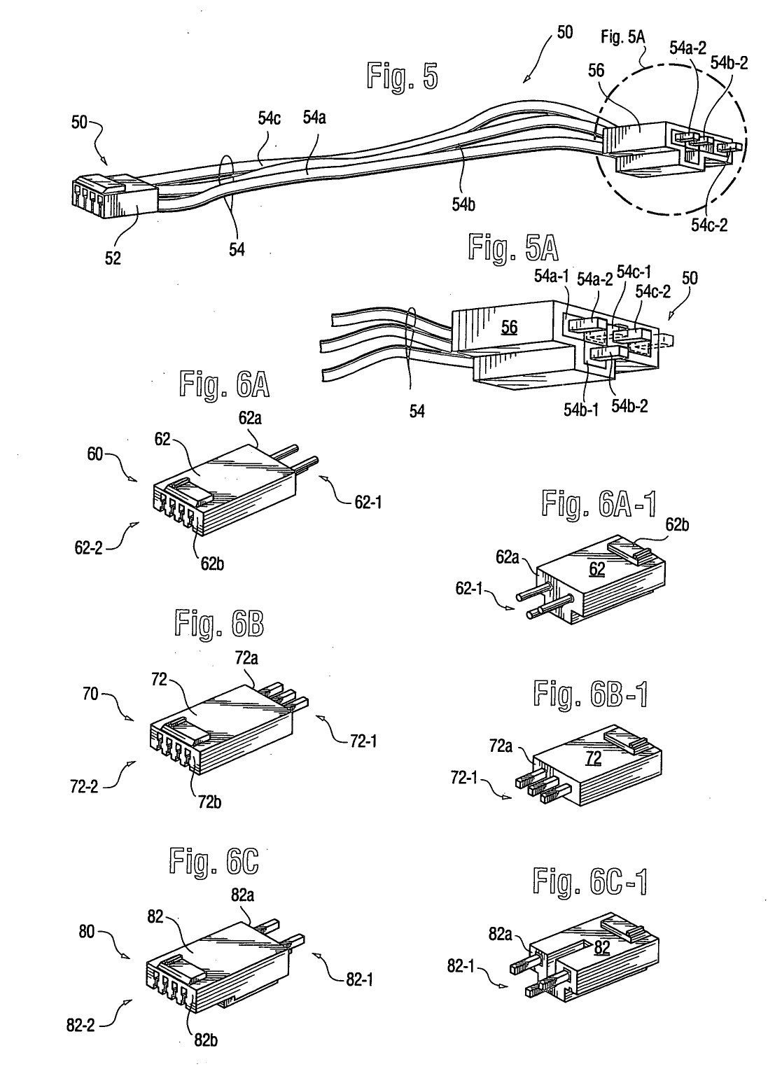

FIG. 5 illustrates an adapter system 50 which incorporates a socket 52 which is compatible with plug 16-2. Conductors 54 extend from socket 52.

A housing 56 carries a plurality of spacing elements such as the elements 54a-1, b-1 and c-1 from which extend plug pins 54a-2, b-2, and c-2 (comparable to the positioning elements 44a-1, b-1, and c-1 and pins 44a-2, b-2 and c-2, best seen in FIG. 4A.) In the system 50, the housing 56 exhibits five locations into which the spacing elements 54a-1, b-1 and c-1 can be moved for purposes of configuring the pins 54a-2, b-2 and c-2 in a way which is compatible with a respective previously installed socket such as one of the sockets 14a, b, . . . n.

By rearranging the connector pins 54a-2, b-2 and c-2, a user or installer can readily configure the adapter system 50 for connection with one or more pre-existing sockets. The configuration process takes place off-line with no connection to the existing sockets or cable 14 thus providing for a user's convenience and safety.

FIGS. 6A, B and C each illustrate two different views of an integrally formed adapter in accordance with the present invention. In FIG. 6A, an adapter 60 has a housing 62 with first and second ends 62a,b. The end 62a carries a plug 62-1 configured to mate with an existing socket, such as socket 14n of cable 14. End 62b carries a socket 62-2 configured to mate with plug 16-2.

Using adapter 60, new detectors can be installed in existing systems quickly and safely. An adapter, such as adapter 60, is especially convenient, as no discrete wires need to be inserted. All wiring between each plug 62-1, end 62a is coupled to an appropriate plug 62-2, end 62b by conductors internal to housing 62. Coupling between respective socket 62-2 and plug 62-1 can be implemented using discrete conductors or printed wiring. Adapter 60 need only be plugged into socket 14a and to plug 16-2 to install detector 16.

FIGS. 6B and 6C illustrate alternate forms of adapters 70 and 80. Each carries a plug on a respective end 72a, 82a whose elements are connected to a socket carried on a respective end 72b, 82b. Socket elements are connected to respective plug elements within a respective housing 72, 82.

Other configurations are possible as adapters 60, 70 and 80 are exemplary only. All such configurations come within the spirit and scope of the present invention. One such variation is to combine movable pins or plug elements, as in FIG. 5 in the integrally formed configurations of FIGS. 6A, B or C. Hence, one adapter 60 can be used with a variety of pre-existing socket configurations.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. An adapter for coupling an existing connector to a different electrical unit than the one for which the existing connector was designed, the adapter comprising:
a non-conductive housing which carries a first set of electrical conductors and a second set of electrical conductors wherein the number of the second set of conductors is the same as the number of the first set of conductors, wherein members of the first set exhibit an electro-mechanical plug-type profile for engagement with socket elements of the existing connector and wherein members of the second set exhibit an electro-mechanical socket-type profile for engagement with a second plug carried by the electrical unit wherein the existing connector and the second plug are incompatible and are not mutually engageable.

2. An adapter as in claim 1 wherein the first set of electrical conductors includes a plurality of flexible, elongated, conductors which terminate in respective rigid conducting prongs engageable with the existing connector.

3. An adapter as in claim 2 wherein the rigid conducting prongs are selectively arranged in a second housing.

4. An adapter as in claim 3 wherein the prongs are inerrable in the second housing in the selected arrangement.

5. An adapter as in claim 2 wherein the prongs are surrounded, at least in part, by an inculpative cover whereby the prongs are extendable axially from the cover.

6. An adapter as in claim 2 wherein the flexible conductors couple the configuration of conductors at the existing connector to the configuration of the second set in the housing.

7. An adapter as in claim 6 wherein the first and second sets each comprise three conductors.

8. An adapter as in claim 6 wherein the existing connector includes at least two conductors for delivery of AC-type power.

9. An adapter as in claim 8 wherein the first set includes three conductors, configured so as to be compatible with the conductors of the connector.

10. An ambient condition detector comprising:
a housing;
a first connector carried on the housing, for mating to a second connector of a compatible form factor and electrical configuration; and
an adapter which engages the first connector whereby the adapter exhibits an output configuration for engaging another, different connector, incompatible with the second connector.

11. A detector as in claim 10 wherein the output configuration is variable and can engage a plurality of different connectors.

12. An adapter as in claim 10 wherein the adapter includes a first set of flexible electrical conductors which terminate in respective rigid conducting pins engageable with the different connector.

13. An as in claim 12 wherein the rigid conducting pins are selectively arranged in a second housing.

14. An adapter as in claim 13 wherein the pins are inerrable in the second housing in the selected arrangement.

15. An adapter as in claim 12 wherein the pins are surrounded, at least in part, by an inculpative cover whereby the pins are extendable axially from the cover.

16. An adapter as in claim 12 wherein the flexible conductors couple the configuration of conductors at the existing connector to the configuration of the first connector.
